(19) United States
(12) Patent Application Publication
(10) Pub. No.: US 2005/0006235 A1
(43) Pub. Date: Jan. 13, 2005

(54) Sensor element

(76) Inventors: Matthias Fuertsch, Gomaringen (DE); Heribert Weber, Nuertingen (DE); Christoph Schelling, Reutlingen (DE)

Correspondence Address: KENYON & KENYON, ONE BROADWAY, NEW YORK, NY, 10004, US

(21) Appl. No.: 10/885,196

(22) Filed: Jul. 6, 2004

(30) Foreign Application Priority Data
Jul. 4, 2003 (DE) 103 30 253.0

(51) Int. Cl. G01N 27/26

(52) U.S. Cl. 204/408

(57) ABSTRACT

A sensor element has at least one heater structure, at least one first circuit trace being provided via which current is injected into the heater structure; at least one second circuit trace being provided via which the current is coupled out of the heater structure, and an arrangement for detecting the resistances of individual sections of the heater structure. According to the present invention, the arrangement for detecting the resistances includes additional, high-resistance measuring lines by which the voltage is tapped directly at the individual segments of the heater structure.

### FIELD OF THE INVENTION

The present invention relates to a sensor element, which has at least one heater structure, at least one first circuit trace being provided via which current is injected into the heater structure; at least one second circuit trace being provided via which the current is coupled out of the heater structure; and an arrangement for detecting the resistances of individual sections of the heater structure.

### BACKGROUND INFORMATION

In practice, sensor elements are utilized within the framework of air-mass sensors to determine air masses, to ascertain the flow velocity and the flow direction. In this case, the heater structure is in most cases arranged on a thin membrane having poor thermal conductivity, the membrane having been produced in the component structure using micromechanical manufacturing methods. The heater structure heats the air above the membrane. When the air is flowing toward the membrane, the heated air above the section of the heater structure first reached by the air is displaced in the direction of another section of the heater structure. This leads to cooling, and thus to reduced resistance, of the section first exposed to the incoming air. The section of the heater structure reached next by the flow is additionally heated by the warmed air, so that the resistance of this section increases. These resistance changes allow inferences with respect to the moving air mass, the flow velocity and the flow direction.

The temperature dependency of the resistance values R(T) may be described as
R(T)=R₀(1+aT),
R₀ being the basic resistance at room temperature, and a being the temperature coefficient of the resistance. Accordingly, temperature-induced resistance changes are proportionally dependent on the variable of basic resistance R₀.

It is problematic in this context that electrical heaters must be realized by low-resistance printed circuit structures. Due to the low basic resistance of the heater structure, the temperature-induced resistance changes that are to be detected are always only relatively low. When measuring such low resistances, all lead tracks and bonding connections influence the measuring result to a considerable extent.

### SUMMARY OF THE INVENTION

The present invention provides a possibility for increasing the measuring accuracy and the measuring sensitivity of sensor elements having heater structures.

To this end, the present invention provides that the arrangement for detecting the resistances of individual sections of the heater structure includes additional, high-resistance measuring lines via which the voltage is sampled directly at the individual sections of the heater structure. This makes it possible to minimize the influence of parasitic resistances, which are often temperature-dependent as well.

In general, there are different possibilities for realizing a sensor element according to the present invention, in particular as far as the type and the arrangement of the heater structures are concerned and also the number and arrangement of the additional high-resistance measuring lines, which are used as voltage taps.

In an advantageous embodiment of the present invention, the individual sections of the heater structure are interconnected in the form of a Wheatstone bridge, using the measuring line. This measure makes it possible to achieve an especially high measuring sensitivity.

As an alternative, it may be advantageous with respect to high measuring accuracy if the individual sections of the heater structure are interconnected with the aid of the measuring lines, in such a way that a 4-point resistance measurement of the individual sections of the heater structure is able to be performed. In this case, the influences of the leads may be eliminated in a simple manner. The measuring accuracy can be increased further by additionally compensating for the influences of the ambient temperature on the measuring result. To this end, the sensor element according to the present invention may include a temperature probe, which is arranged at a sufficient distance from the heater structure.

### BRIEF DESCRIPTION OF THE DRAWINGS

FIG. 1 shows the plan view of a first sensor element configured according to the present invention, which has two autonomous double-heater structures.

FIG. 2 shows the plan view of a second sensor element configured according to the present invention, which has two autonomous double-heater structures.

FIG. 3 shows a bridge interconnection of the resistors of the sensor elements shown in FIGS. 1 and 2.

FIG. 4 shows the plan view of a third sensor element configured according to the present invention, which has two double-heater structures sharing current incoupling and current outcoupling.

FIG. 5 shows the plan view of a fourth sensor element configured according to the present invention, which has a double-heater structure.

FIG. 6 shows the plan view of a fifth sensor element configured according to the present invention, which has a double-heater structure.

### DETAILED DESCRIPTION

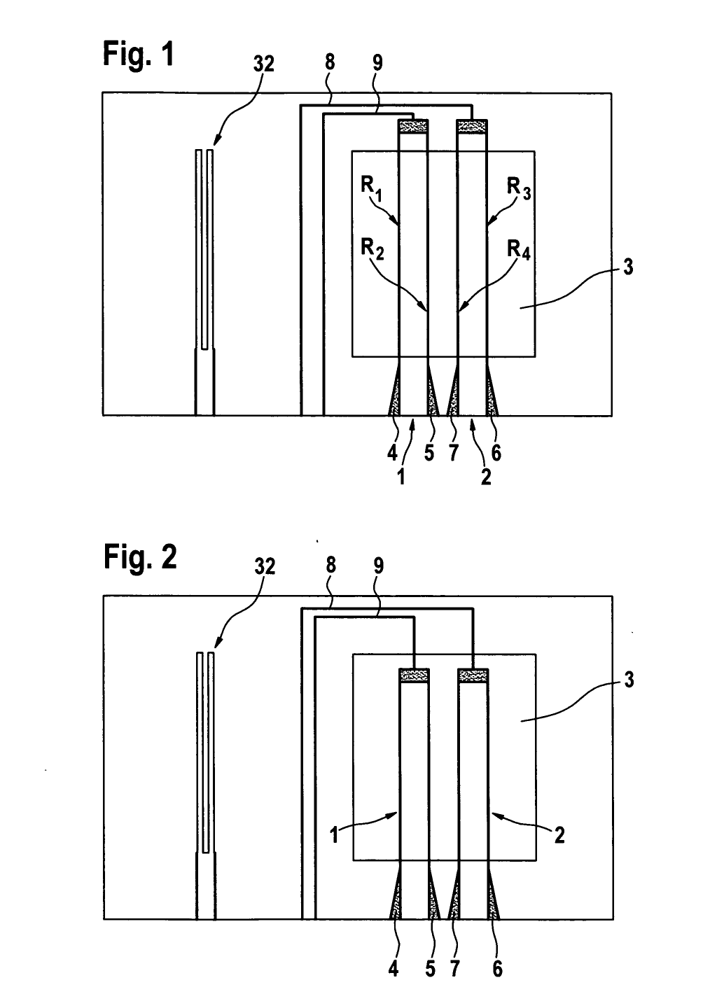

All sensor elements shown in FIGS. 1 and 2 as well as 4, 5 and 6 are used to detect fluid flows, i.e., the mass, the velocity and direction of a flowing fluid, and may be utilized within the framework of a mass air-flow sensor, for example for applications in the automotive sector.

Each illustrated sensor element is produced using standard methods of semiconductor technology and micromechanics, and includes at least one heater structure, which is arranged on a thin membrane, having poor thermal conductivity, of the component structure. The membrane is usually made up of a plurality of layers made from SiO2, Si3N4, SiC, etc, for example. The heater structure and the circuit traces may be made up of one or also a plurality of layers, for example of Al, Pt, Ni, polysilicon etc. In addition, cover layers made of SiO2, Si3N4, SiC etc. are usually provided as well. All of these layers are deposited on a silicon wafer and patterned according to function. The self-supporting membrane is produced by patterning of the back of the silicon wafer, the silicon being removed in the region of the membrane to be produced. As an alternative, the self-supporting membrane may also be realized by a cavity introduced from the front, using known surface micromechanical (SMM) technologies.

The sensor elements shown in FIGS. 1 and 2 in each case include two double-heater structures 1 and 2 having two resistors R1 and R2 or R3 and R4, respectively, which are in the form of heating-conductor segments, connected in series and arranged on membrane 3 in parallel to one another. Both double-heater structures 1 and 2 have an independent current supply. To this end, a first circuit trace 4 or 6 is provided via which current is fed into double-heater structure 1 or 2, respectively, and a second circuit trace 5 or 7, via which the current is coupled out of double-heater structure 1 or 2, respectively. Circuit traces 4 through 7 are comparatively broad, i.e., have low resistance, and taper in the connecting region to heating-conductor segments R1 through R4 to minimize the influence of the lead resistances on the measuring result.

Provided for the measured-value acquisition are two high-resistance measuring lines 8 and 9 by which the voltage is tapped directly in the connecting region of the two resistors R1 and R2 or R3 and R4, respectively, which are arranged in parallel to one another. In the exemplary embodiment shown in FIG. 1, the measuring-line connections are arranged on the “mainland” of the sensor element, whereas they are arranged in the membrane region in the exemplary embodiment shown in FIG. 2.

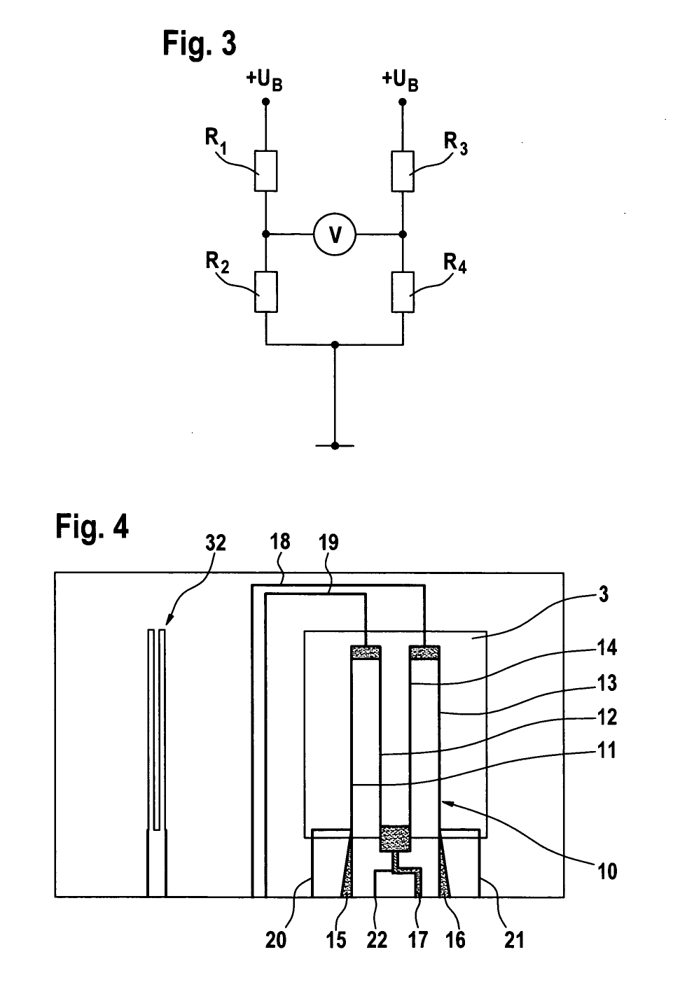

Measuring lines 8 and 9 or the measuring-line connections illustrated in FIGS. 1 and 2, allow heating-conductor sections R1 through R4 to be interconnected to a Wheatstone bridge as shown in FIG. 3.

The sensor element shown in FIG. 4 includes a heater structure 10, which is made up of two double-heater structures having shared current incoupling and current outcoupling. Heating-conductor segments 11 through 14 of the two double-heater structures are arranged on membrane 3 in parallel to one another. In the present example, the current is to be supplied via the two circuit traces 15 and 16 arranged at the extremities. The current is coupled out via centrically arranged circuit trace 17. This exemplary embodiment provides a total of five high-resistance measuring lines for the measured-value acquisition. Using two measuring lines 18 and 19, the voltage is tapped directly in the connecting region of heating-conductor segments 11 and 12 or 13 and 14, respectively. In addition, two measuring lines 20 and 21 are provided via which the voltage may be tapped at the current-infeed points, and a measuring line 22 is provided via which the voltage is able to be tapped at the current-outcoupling point. All measuring-line connections are situated in the membrane region, but they may also be arranged outside of the membrane area analogously to FIG. 1. The measuring-line connections of the exemplary embodiment illustrated in FIG. 4 allow a 4-point measurement in which the resistances of heating-conductor segments 11 through 14 are able to be determined individually.

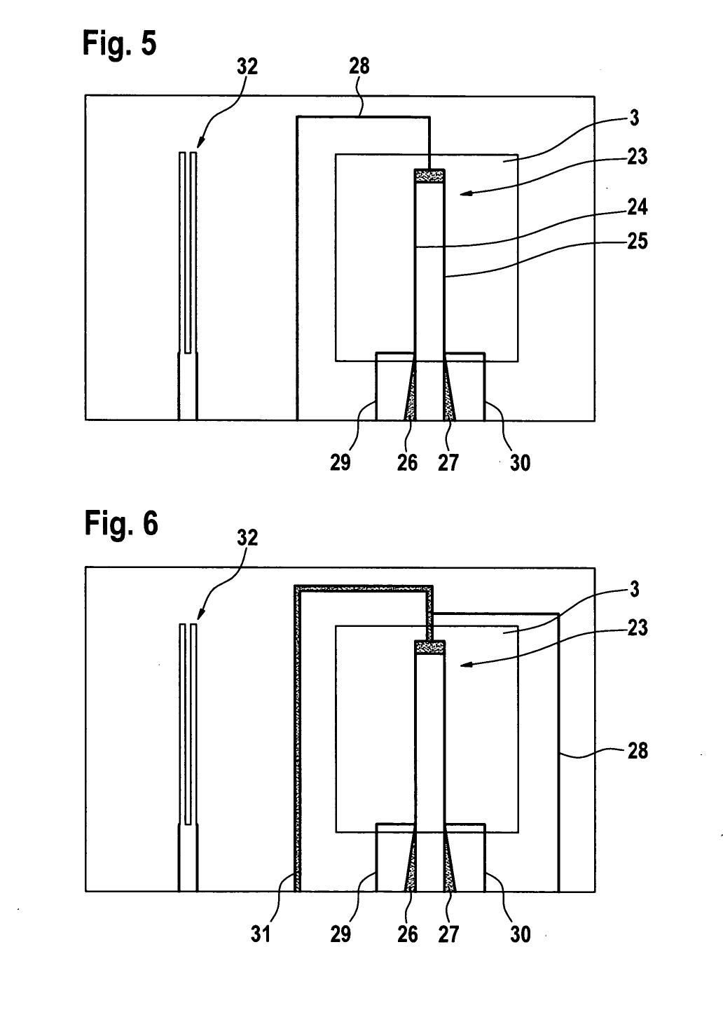

This possibility is also given in the exemplary embodiment shown in FIG. 5. Here, heater structure 23 includes only two heating-conductor segments 24 and 25, which are connected in series and arranged on membrane 3 in parallel to one another. Current is supplied via a circuit trace 26 and coupled out via a circuit trace 27. The measured-value acquisition is performed with the aid of three high-resistance measuring lines. Using a measuring line 28, the voltage is tapped directly in the connecting region of heating-conductor segments 24 and 25. The voltage at the current-infeed point and at the current-outcoupling point is tapped via the other two measuring lines 29 and 30. Here, too, all measuring-line connections are arranged in the membrane region by way of example.

The sensor element shown in FIG. 6 differs from the sensor element shown in FIG. 5 by a shared current-supply line and current return line 31 of the two heating-conductor segments 24 and 25, which allow an independent temperature adaptation for each of the two heating-conductor segments 24 and 25.

In all five exemplary embodiments shown in the figures, a temperature probe 32, which may likewise be produced together with the heater structure using standard methods of semiconductor technology, is arranged outside the membrane region. This temperature probe may be utilized to compensate for temperature influences on the measuring results.

Analogously to the representations in FIG. 1 and FIG. 2, the heating-conductor structures in all indicated examples may extend from the membrane region to the mainland region, where measuring lines for the voltage tap(s) may be connected.

Reference Numerals

1 double-heater structure (FIGS. 1 and 2)

2 double-heater structure (FIGS. 1 and 2)

3 membrane

4 circuit trace—current infeed/current outcoupling

5 circuit trace—current outcoupling/current infeed

6 Circuit trace—current infeed/current outcoupling

7 circuit trace—current outcoupling/current infeed

8 measuring line

9 measuring line

10 heater structure (FIG. 4)

11 heating-conductor section

12 heating-conductor section

13 heating-conductor section

14 heating-conductor section

15 circuit trace—current infeed/current outcoupling

16 circuit trace—current infeed/current outcoupling

17 circuit trace—current outcoupling/current infeed

18 measuring line

19 measuring line

20 measuring line

21 measuring line

22 measuring line

23 heater structure (FIGS. 5 and 6)

24 heating-conductor section

25 heating-conductor section

26 circuit trace—current infeed/current outcoupling

27 circuit trace—current outcoupling/current infeed

28 measuring line

29 measuring line

30 measuring line

31 current supply and current return line

32 temperature probe

1. A sensor element, comprising:
at least one heater structure;
at least one first circuit trace via which a current is injected into the heater structure;
at least one second circuit trace via which the current is coupled out of the heater structure; and
an arrangement for detecting resistances of individual sections of the heater structure, wherein the arrangement for detecting the resistances include additional, high-resistance measuring lines by which a voltage is tapped directly at the individual sections of the heater structure.

2. The sensor element as recited in claim 1, wherein the individual sections of the heater structure are interconnected to a Wheatstone bridge via the measuring lines.

3. The sensor element as recited in claim 1, wherein the individual sections of the heater structure are interconnected via the measuring lines in such a way that a 4-point resistance measurement may be implemented for an electrical characterization of the individual sections of the heater structure.

4. The sensor element as recited in claim 1, wherein geometrical dimensions of the heater structure and distances between the individual sections of the heater structure are optimized with respect to maximum sensitivity.

5. The sensor element as recited in claim 1, further comprising:
at least one temperature probe for a compensation of temperature influences.

6. The sensor element as recited in claim 1, wherein the heater structure is arranged on a region having good thermal insulation.

7. The sensor as recited in claim 7, wherein the region includes a thin membrane having a poor thermal conductivity.

8. The sensor element as recited in claim 1, wherein the heater structure is a free-supporting heating structure over a substrate.

9. The sensor element as recited in claim 7, wherein voltage taps realized via the measuring lines are situated one of in the region having good thermal insulation and outside of the region having good thermal insulation.

10. The sensor element as recited in claim 7, wherein voltage taps realized via the measuring lines are situated one of in the region of the membrane and in the region of a mainland surrounding the membrane.

11. A method of using a sensor element including at least one heater structure, at least one first circuit trace via which a current is injected into the heater structure, at least one second circuit trace via which the current is coupled out of the heater structure, and an arrangement for detecting resistances of individual sections of the heater structure, the arrangement for detecting the resistances including additional, high-resistance measuring lines by which a voltage is tapped directly at the individual sections of the heater structure, the method comprising:
causing the sensor element to detect a fluid flow.

12. The method as recited in claim 11, wherein the sensor element is included in one of an air-mass flow sensor, a thermal acceleration sensor, an inclinometer, an angular-position sensor, and an adiabatic pressure sensor.
